(19) United States
(12) Patent Application Publication
(10) Pub. No.: US 2003/0085928 A1
(43) Pub. Date: May 8, 2003

(54) Business model for the management of real estate in graphical menus

(75) Inventors: Frederik Ekkel, Cupertino, CA (US); Peter Joseph Swillens, Cupertino, CA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/004,049

(22) Filed: Nov. 2, 2001

(51) Int. Cl. G09G 5/00

(52) U.S. Cl. 345/810

(57) ABSTRACT

A business model is provided for the sharing of the real estate of a graphical user interface for the representation of third party's applications available on a device controlled through the graphical user interface. A control user interface element is displayed on the graphical user interface in association with the application. The provider of the application is charged based on the duration of the display of the element in association with the application.

### FIELD OF THE INVENTION

The invention relates to the offering and distribution of applications for electronic equipment. The invention also relates to the sharing of real-estate in graphical menus used to control such electronic equipment.

### BACKGROUND ART

Service providers compete to gain user attention and user fidelity to their respective services. The development and the implementation of personal and home network standards such as Bluetooth, 802.11 or Hiperlan/2 allow these providers to access the individual's home and personal environment via the individual's network-enabled electronic devices. As a result, the networking capabilities of consumer electronic devices open doors to a great variety of applications to be offered on these devices. For example, a user of a personal digital assistant can choose among dozens of providers for ancillary services in various fields, e.g. photo album, gaming or real-time news delivery. These services are often advertised and delivered in an unstructured manner with limited control of the original manufacturer of the device.

In addition, providers also seek to be as close as possible to the individual to better capture his attention and to better promote their services. One way of achieving that purpose is to capture a portion of graphical menus that the individual uses to control his personal electronic equipment. This practice is, for example, well-known in advertising and tends also to be true for the control of applications in some market segments. For example in the PC market, application providers compete to be entitled to a portion of real estate of the individual's computer desktop to insert an icon representing their application. Graphical menus mentioned herein may also be that of a customizable remote control or a control menu displayed on a television screen for example.

### SUMMARY

It is an object of the invention to provide a business model between a manufacturer of a device and providers of applications for the device.

It is another object of the invention to provide a business model that can be mapped onto the promotion and distribution of applications through electronic equipment.

To this end, a method of doing business of the invention enables to display a control user interface element on a graphical user interface. The display is in association with an application available on a device controlled through the graphical user interface. The application is at least partially controllable using the control user interface element. A business model of the invention also comprises charging a provider of the application based on a duration of the display of the control user interface element in association with the application.

The inventor has realized that the manufacturer of the device or any party involved in the conception of the device, does not necessarily benefit from other providers' applications that the individual may install on the device at a later time. One or more embodiments of the invention give a possible business approach to this problem. Indeed, the provider is charged based on the duration of the display of the control element in association with the application. The control element may be an existing element of the graphical user interface (GUI) modified or re-configured in order to be associated with the application. Alternatively, the control element can be added to the GUI when the application is installed on the device or at a later time. The individual may choose himself whether to associate the control element with the application or not. Alternatively, the association may be imposed to the individual who cannot freely modify the GUI. An advantage of the invention is to allow the original manufacturer of the device to share revenues with providers of applications installed a later time. By basing the revenue model on the duration of the display of the element in association with the application, the invention permits to charge the service provider when the application is accepted and actually in use by the individual. Indeed, the display of the element in association with the application can be seen as an indication of the acceptance and usage of the application. For example, an individual who does not use the application may decide to remove the control element from the GUI or may dissociate the element from the application. Thus, an advantage of one or more embodiments of the invention is to link the revenue stream with customers acceptance of the application. As a consequence, a business model according to one or more embodiments of the invention may not significantly harm a service provider launching a new service.

### BRIEF DESCRIPTION OF THE DRAWINGS

The invention is explained in further details, by way of examples, and with reference to the accompanying drawing wherein:

FIG. 1 shows a device used for the control of electronic devices in the invention; and,

FIG. 2 shows a graphical user interface of the invention.

Elements within the drawing having similar or corresponding features are identified by like reference numerals.

### DETAILED DESCRIPTION

The invention relates to the sharing of real estate in graphical menus that individuals use to control their home equipment or any other electronic device controllable through a GUI. A graphical user interface of the invention may be dedicated to the control of a plurality of different devices and/or a plurality of different applications. The same graphical user interface is therefore used to control various applications that can differ from one device to the other, from one application to the other or from one provider to the other. One or more embodiments of the invention give a solution to structure the use of real estate of GUI for ancillary service applications.

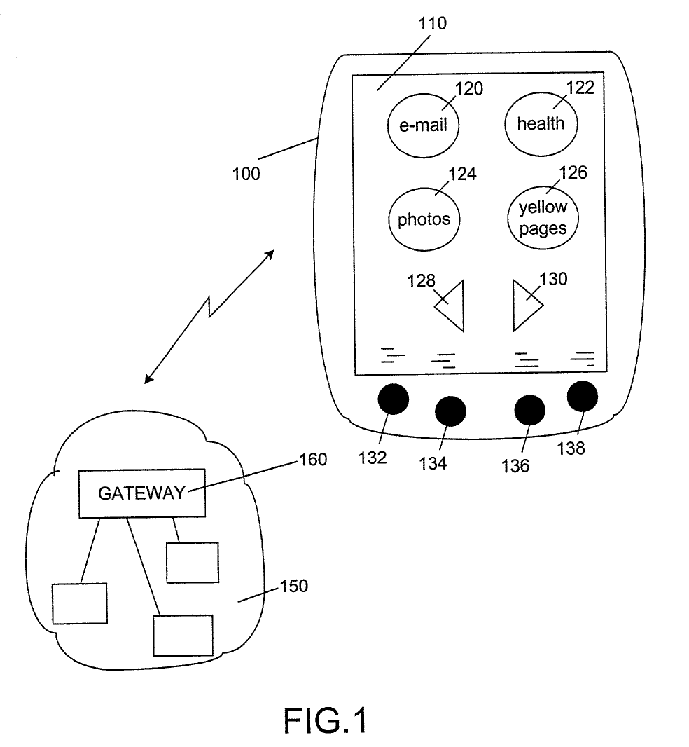

FIG. 1 is an exemplary embodiment of a control device 100 displaying part of a graphical user interface 110. An individual uses GUI 110 to control a set 150 of electronic devices. In this embodiment, these electronic devices 150 are interconnected and form a home network that a home gateway unit 160 connects to a public or semi-public network, e.g. the Internet. The home gateway unit 160 communicates with other devices in the home network over wireless or wired communication channels. The control device 100 enables the individual to operate applications on the gateway unit 160 or any other one of the devices 150. Besides an application may be operated in the gateway unit 160 and actually rendered in another device such as a television or an audio system. An application may also be run in a distributed manner over the home network.

The GUI 110 is comprised of tiers of graphical menus. In FIG. 1, the device 100 displays one of these graphical menus. The GUI 110 is configured as follows. When the device 100 is switched on, a main menu is displayed linking to a plurality of sub-menus. The main menu is hereafter referred to as the first tier of menus of the GUI 110. The sub-menus, directly accessible from the main menu, form a second tier of graphical menus. The GUI 110 may also comprise other tiers of menus. For example, a third tier of menus is comprised of graphical menus directly accessible from one of the graphical menus of the second tier. A menu A is said to be directly accessible from a menu B when selecting an element in the menu B results in the display of the menu A.

The graphical menu displayed by the device 100 as shown in FIG. 1 comprises eight graphical user interface elements 120-138. The UI elements 120-130 are touch-selectable control elements and the UI elements 132-138 are displayed graphics or words associated with hard buttons. The elements 128-138 are not discussed herein. Each control element 120-126 represents a service application that the individual can operate on one of the devices 150 controllable through the graphical user interface 110. The control element 120 is associated with an email application. The control element 122 is associated with a health application. The control element 124 is associated with a photo album application. The control element 126 is associated with a yellow pages application. The four applications have been chosen for illustrative purposes only and should not limit the scope of the invention. Other applications, e.g. online gaming, pay-per-view television, instant messaging, internet service provider and music jukebox, are also within the scope of the invention.

In an embodiment of the invention, selection of one of the GUI elements 120-126 leads to a graphical command menu associated with the respective application. Such a graphical command menu may comprise other GUI elements used to transmit commands to operate the application, e.g. “play” command, “next” command, “send” command or “save” command. In another embodiment, selection of one of the GUI elements 120-126 may activate the respective application only and does not trigger the display of a subsequent graphical command menu on the device 100. However a graphical command menu may be still displayed on another one of the devices 150 in response to the selection of the element 120-126. For example, selecting the element 122 may initiate the email application in the home gateway unit 160 with the email application being actually rendered to the individual on a television screen connected to the gateway unit 160. The individual can check or write emails using a wireless keyboard associated with the television or the gateway unit 160 without further needing the GUI 110.

In this embodiment, the GUI 110 is partially customizable in the sense that the individual can make modifications to it. The individual may modify the interface 110 by changing the configuration of the elements 120-126, moving the elements 120-126, removing one or more elements 120-126 or adding icons or other elements to the interface 110. As mentioned above, the device 100 comprises a touch-screen and each element 120-126 is displayed as a touch-selectable icon displayed on the screen. In another embodiment, the elements 120-126 are hypertext elements respectively associated with an application. The design of the elements 120-126 may be specific to the associated application or may be selected among a finite number of possible designs. Besides, the design of the elements 120-126 may be left at the individual's discretion or may be imposed by the provider of the application. The elements 120-126 may also be icons or hypertext displayed on a regular screen that the individual can select using a cursor or hard buttons. Indeed, in another example embodiment, further applications may also be associated with the hard buttons 132-138 in the same manner applications are associated with the elements 120-126.

The management and sharing of real estate in the GUI 110 is based on a business model of the invention as explained hereinafter. A business model of the invention may map the business relationship between a party providing or manufacturing the gateway 160 and the device 100 on one side and the application providers on the other side. However the invention may also be applied to any party charging application providers for the use of real estate of a GUI according to the invention. In this embodiment, the providers of the four applications are respectively charged based on the duration of the display of the elements 120-126 in association with their respective applications.

This duration of the association may be influenced by the individual only, the service provider or both. For example, the elements 120-126 may have been added automatically to the GUI 110 when the individual installed the corresponding application on one of the devices 150. In another embodiment, the element 120-126 may be added to the GUI 110 upon request of the individual at any time after the application was installed on the devices 150. These elements 120-126 may, then, be automatically removed from the GUI 110 when the respective applications are uninstalled from the devices 150. Alternatively, the individual may remove the element 120-126 himself because e.g. the individual has no interest in the application anymore or considers that the element 120-126 pollutes the GUI 110. Moreover, the elements 120-126 may also be elements of the GUI 110 that existed prior to the installation of the respective applications and that are reconfigured upon association with the applications. In yet another embodiment, the elements 120-126 may also be automatically removed from the GUI 110 or dissociated from the corresponding application if the individual has not used the application for a certain period of time or based on statistic in a history trail. The devices 150 may be linked with a back-end system for keeping this history trail. The back-end system can reside in the residential gateway 160 or can be a presence on the Internet. This back-end may manage pieces of software associated with the applications and may take care of the actual transport of the applications onto the devices 150. The history trail may indicate how often the individual uses the applications, the commands sent by the individual from the device 100 or a ranking of the applications by the individual. The history trail may also comprise a usage pattern of each application by keeping track of each instance of the individual logging in or initiating the application.

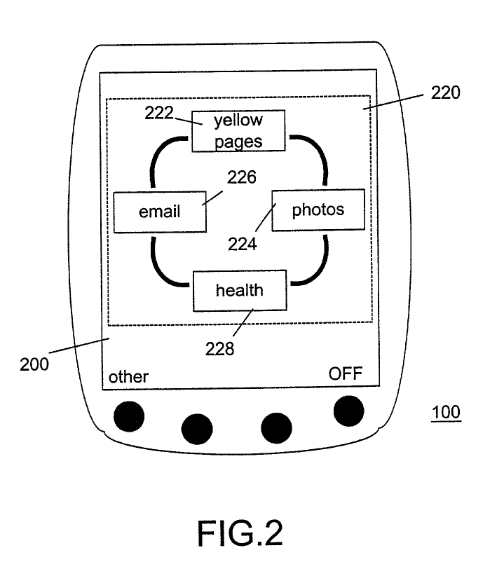

FIG. 2 shows an example embodiment of a graphical menu 200 displayed at a given instant on the device 100. The graphical menu 200 may be the main menu of the GUI 110 displayed to the individual when the device 100 is powered on. The graphical menu 200 comprises a so-called carrousel 220 of applications. The carrousel 220 advertises a fixed number of applications 222-228, four in this embodiment, that the individual can choose from. As will be explained hereinafter, the individual may select the application to be added to the carrousel 220. The applications in the carrousel 220 may be the ones preferred by the individual or the ones that the individual most frequently uses. The device 100 may also permit to control other applications accessible via a GUI element “Other” in the menu 200.

In this embodiment, the individual can choose applications from a plurality of applications advertised to him. For example, a web-site may promote these third party's applications that the individual can download and install onto one or more of the devices 150. When selecting one of the advertised applications, the individual may choose to have the GUI 110 of the device 100 modified to enable control of the application. The individual may also choose to have the application added to the carrousel 220 thereby replacing another application already present in the carrousel 220. Alternatively, the individual can choose to have the application associated with another UI element in tiers of menus of the GUI 110 lower than the main menu.

A provider whose application is associated with a control element of the GUI 110 is charged based on the duration of the display. The provider may be charged so long as the application is associated with an element in the GUI 110. For example, a provider may be charged a lump sum when the application first appears on the GUI 110 and then the provider may be charged a fixed fee per day or week of representation of the application on the GUI 110 of the individual's device 100. The provider may also be charged a fixed fee per usage of the application. The fee may vary based on the tier of graphical menu on which the application is represented. Thus, providers of the four applications in the carrousel 220 may be charged at a higher rate than providers whose applications are represented in other sub-menus. The provider may also be charged each time the individual selects the element representing the application in the GUI 110. In another embodiment, a highest and most expensive tier may comprise the hard buttons 132-138. A provider having his application associated with one of the hard buttons 132-138 will be charged a higher price than a provider of an application associated with the elements 120-126.

In another embodiment, the individual is not able to modify the carrousel 220 and the applications 222-228 in the carrousel 220. The manufacturer of the device 100 or any other party decides which applications should compose the carrousel 220. For example, application providers may “lease” real-estate of the individual's GUI 110 from the manufacturer directly. The providers are charged based on how long an element of the GUI 110 is associated with their applications.

The invention is however not limited to the home environment and other environment must be taken into consideration. It is also within the scope of the invention to consider other environment than the home environment given herein. The invention relates any graphical user interface whose real estate can be shared and attributed to providers following a business model of the invention. For example, the invention can be mapped onto the retribution from space allocating in web sites.

It is also to be noted that the invention encompasses any sort of graphical user interface whether the GUI is designed for a television screen, a computer screen, an audio system small LCD screen, a personal digital assistant and the like. Besides the presence of a home gateway unit was only given as an example and in other embodiments of the invention, the graphical user interface may be displayed and rendered by the device it controls.

As used herein the terminology “charging” is not limited to the exchange of money from one party to the other and any sort of grant of advantages or value exchange is also in the scope of the invention.

1. A method of doing business, the method comprising:
enabling a display, on a graphical user interface, of a control user interface element in association with an application that is available on a device controlled through the graphical user interface, the application being at least partially controllable using the control user interface element; and,
charging a provider of the application based a duration of the display of the control user interface element in association with the application.

2. The method of claim 1, wherein the provider associates the control user interface element with the application in the graphical user interface.

3. The method of claim 1, wherein a user of the device associates the control user interface element with the application in the graphical user interface.

4. The method of claim 1, further comprising:
enabling a user of the device to select the application from a plurality of applications; and,
upon selection by the user, automatically adding the control user interface element to the graphical user interface.

5. The method of claim 1, wherein the element is previously present in the graphical user interface and further comprising:
enabling a user of the device to select the application from a plurality of applications; and,
upon selection by the user, enabling to associate the control user interface element with the application.

6. The method of claim 1, wherein the element is previously present in the control user interface and further comprising:
enabling a user of the device to select the application from a plurality of applications; and,
upon selection by the user, modifying the control user interface element.

7. The method of claim 1, wherein the control user interface element is an icon representative of the application.

8. The method of claim 1, further comprising:
enabling the provider to advertise the application.

9. The method of claim 1, further comprising:
enabling a user of the device to select the application from a plurality of applications; and,
upon selection of the application by the user, enabling a download onto the device of a software component associated with the application.

10. The method of claim 1, wherein the graphical user interface comprises a plurality of graphical menus configured in respective tiers and further comprising:
charging the provider based on the tier of the graphical menu containing the element.

11. The method of claim 1, wherein the charging is also based on a history trail comprising a usage pattern of the application.

12. The method of claim 1, wherein the control user interface element is comprised in a carrousel of control user interface elements associated with respective applications.

13. The method of claim 12, wherein a user of the device selects the applications in the carrousel.

14. The method of claim 12, further comprising:
selecting the applications comprised in the carrousel;
charging respective providers of the applications based on a duration of the applications being comprised in the carrousel.

15. The method of claim 1, wherein the provider is charged per day of the display.

16. The method of claim 1, further comprising:
charging a lump sum to the provider upon display of the control user interface element in association with the application.

17. The method of claim 1, wherein the application comprises an email service.

18. The method of claim 1, wherein the application comprises a news service.

19. The method of claim 1, wherein the application comprises instant messaging.

20. The method of claim 1, wherein the application comprises audio files retrieving.
